(19) United States
(12) Patent Application Publication
(10) Pub. No.: US 2022/0416661 A1
(43) Pub. Date: Dec. 29, 2022

(54) SIMBO BUCK-BOOST INVERTING CONVERTER AND CONTROL METHOD THEREOF

(71) Applicant: BravoTek Electronics Co., Ltd., Zhubei City (TW)

(72) Inventors: Wei-Chun CHENG, Taipei City (TW); William CHEN, Taipei City (TW); Wei-Hsin WEI, Zhubei City (TW)

(21) Appl. No.: 17/358,792

(22) Filed: Jun. 25, 2021

(51) Int. Cl. H02M 3/158; H02M 1/08; H02M 7/539

(52) U.S. Cl. CPC H02M 3/1582; H02M 1/08; H02M 7/539; G09G 2310/0264; G09G 3/3225

(57) ABSTRACT

Provided is a SIMBO buck-boost inverting converter including: a power stage for receiving an input voltage to generate first and positive output voltages and a negative output voltage, the power stage including a plurality of switches and an inductor; a control circuit for generating a plurality of control voltages based on the first and the second positive output voltages, the negative output voltage and a current of the inductor; an energy generation and distribution circuit for generating a plurality of duty cycles based on the control voltages; and a logic control and gate driving circuit for generating a plurality of switch control signals for controlling the switches of the power stage based on the duty cycles; wherein the control circuit and the energy generation and distribution circuit feedback-control and adjust the duty cycles to adjust a balance between an input energy and an output energy.

### TECHNICAL FIELD

The disclosure relates in general to a SIMBO (Single Inductor Multiple Bipolar Output) buck-boost inverting converter and a control method thereof.

### BACKGROUND

The active matrix OLED (AMOLED) display panel becomes very popular for mobile display applications (for example, smart watches, smart phones) owing to its advantages such as high contrast ratio, high display quality, low power consumption and low material cost. In mobile display applications, the circuit board has limited area and thus a small size power circuit is preferred.

FIG. 1A shows a simplified pixel circuit diagram. FIG. 1B shows signal waveform in FIG. 1A. The driving circuit 100 is for driving the pixel circuit P. The driving circuit 100 receives a positive power AVDD and display data for generating driving data and scan signals to the pixel circuit P. The pixel circuit P includes: transistors M1-M2, a capacitor C and an OLED O.

A positive power OVDD and a negative power OVSS provide positive voltages and negative voltages to the pixel circuit P and thus the pixel circuit P generates a driving current I. The capacitor C holds a source-gate voltage VSG2 of the transistor M2 to provide the driving current I. Voltage ripples of the positive power OVDD and the negative power OVSS may directly affect the driving current I. Thus, in order to improve the display performance, the voltage ripples of the positive power OVDD and the negative power OVSS have to be minimized. Besides, compared with the positive power OVDD and AVDD, the negative power OVSS tolerances higher voltage ripples.

The following table shows AVDD, OVDD and OVSS used in different OLED display panel generations, wherein the input voltage VIN, if provided by Li battery, is ranged between 2.7V˜4.5V.

| | Generation 1 | Generation 2 | Generation 3 |
|---|---|---|---|
| AVDD | N/A | 3.3 V | 2.8 V |
| OVDD | 4.6 V | 3.3 V | 2.8 V |
| OVSS | −2.4 V | −3.3 V | −2.8 V |
| Mode | Boost + inverting | Buck/boost + inverting | Buck + inverting |

As shown in FIG. 1B, after the enable signal is asserted, during the first period t₁, the positive power AVDD is output; during the second period t₂, the positive power OVDD is output; and during the third period t₃, the negative power OVSS is output. That is, output of the positive power AVDD and OVDD is earlier than the negative power OVSS. Until output of the positive power AVDD and OVDD is ready, the negative power OVSS is output.

In the prior art, for boost converting, an inductor charge cycle is added, resulting wide switching frequency variation and large voltage ripples. Still further, when the operation condition (the input voltage or the output current) changes, the prior control scheme relies on the modulation of the error amplifier, which limits performance on line transient response and cross regulation effect.

Thus, how to improve performance and prevent cross regulation effect, while meeting requirements by different OLED display panel generations is major concern.

### SUMMARY

According to one embodiment of the application, provided is a SIMBO (Single Inductor Multiple Bipolar Output) buck-boost inverting converter including: a power stage for receiving an input voltage to generate a first positive output voltage, a second positive output voltage and a negative output voltage, the power stage including a plurality of switches and an inductor; a control circuit coupled to the power stage, for generating a plurality of control voltages based on the first positive output voltage, the second positive output voltage, the negative output voltage and a current of the inductor; an energy generation and distribution circuit coupled to the control circuit, for generating a plurality of duty cycles based on the control voltages; and a logic control and gate driving circuit coupled to the energy generation and distribution circuit, for generating a plurality of switch control signals for controlling the switches of the power stage based on the duty cycles; wherein the control circuit and the energy generation and distribution circuit feedback-control and adjust the duty cycles to adjust a balance between an input energy from the input voltage and an output energy sent to the first positive output voltage, the second positive output voltage and the negative output voltage.

According to another embodiment, provided is a control method for SIMBO (Single Inductor Multiple Bipolar Output) buck-boost inverting converter, the control method including: receiving an input voltage to generate a first positive output voltage, a second positive output voltage and a negative output voltage by a power stage, the power stage including a plurality of switches and an inductor; generating a plurality of control voltages based on the first positive output voltage, the second positive output voltage, the negative output voltage and a current of the inductor; generating a plurality of duty cycles based on the control voltages; and generating a plurality of switch control signals for controlling the switches of the power stage based on the duty cycles; wherein feedback-controlling and adjusting the duty cycles to adjust a balance between an input energy from the input voltage and an output energy sent to the first positive output voltage, the second positive output voltage and the negative output voltage.

### BRIEF DESCRIPTION OF THE DRAWINGS

FIG. 1A shows a simplified pixel circuit diagram.

FIG. 1B shows signal waveform in FIG. 1A.

FIG. 2 shows a circuit diagram of a SIMBO (Single Inductor Multiple Bipolar Output) boost-buck inverting converter according to one embodiment of the application.

FIG. 3A to FIG. 3C show signal waveforms of the SIMBO boost-buck inverting converter according to one embodiment of the application.

FIG. 4A to FIG. 4B show signal waveforms of the SIMBO boost-buck inverting converter according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENT

Technical terms of the disclosure are based on general definition in the technical field of the disclosure. If the disclosure describes or explains one or some terms, definitions of the terms are based on the description or explanation of the disclosure. Each of the disclosed embodiments has one or more technical features. In possible implementation, one skilled person in the field could selectively implement part or all technical features of any embodiment of the disclosure or selectively combine part or all technical features of the embodiments of the disclosure.

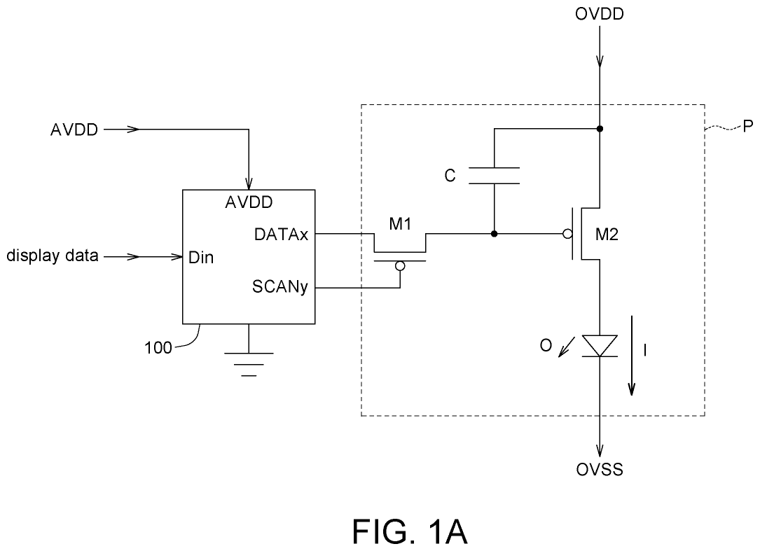

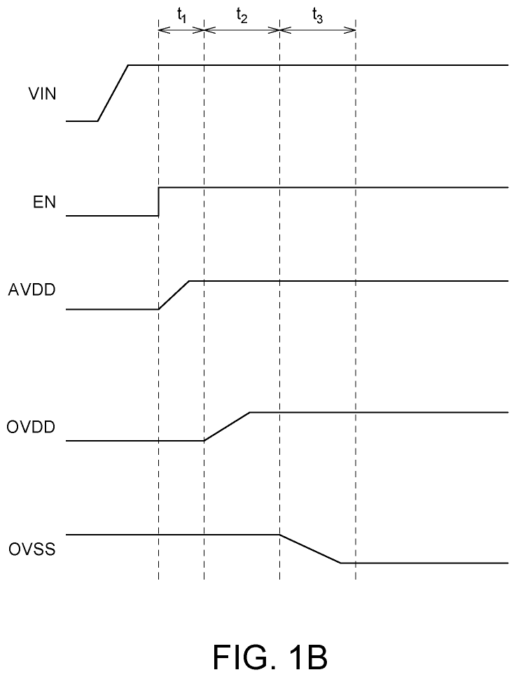

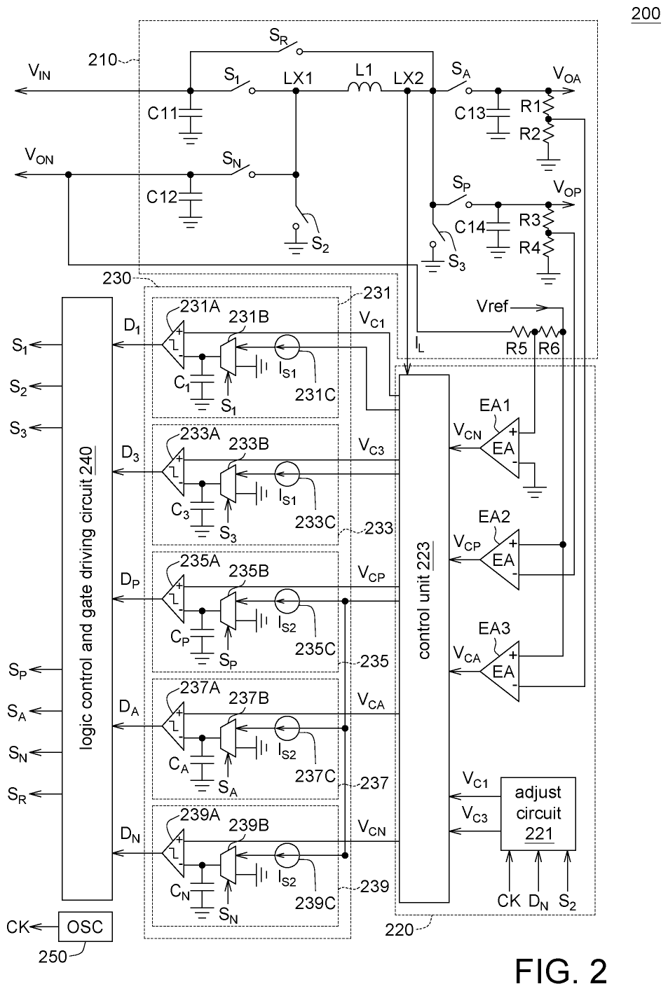

FIG. 2 shows a circuit diagram of a SIMBO (Single Inductor Multiple Bipolar Output) boost-buck inverting converter according to one embodiment of the application. The SIMBO boost-buck inverting converter 200 includes a power stage 210, a control circuit 220, an energy generation and distribution circuit 230, a logic control and gate driving circuit 240 and a clock generation circuit 250. The SIMBO boost-buck inverting converter 200 generates two positive output voltages V_{OP} and V_{OA}, and one negative output voltage V_{ON} from an input voltage V_{IN}. The positive output voltages V_{OP} and V_{OA}, and the negative output voltage V_{ON} may be used to implement power AVDD, OVDD and OVSS in FIG. 1A.

The power stage 210 includes switches S₁, S₂, S₃, S_{P}, S_{A}, S_{N}, S_{R}, an inductor L1, capacitors C11-C14 and resistors R1-R6.

The switch S₁ is coupled between the input voltage V_{IN} and a first node LX1. In the application, the symbol “S₁” may also be used to indicate the switch control signal for controlling the switch S₁ and so on. The switch S₂ is coupled between the first node LX1 and GND. The switch S₃ is coupled between a second node LX2 and GND. The switch S_{P} is coupled between the second node LX2 and the positive output voltage V_{OP}. The switch S_{A} is coupled between the second node LX2 and the positive output voltage V_{OA}. The switch S_{N} is coupled between the first node LX1 and the negative output voltage V_{ON}. The switch S_{R} is coupled between the input voltage V_{IN} and the second node LX2.

The inductor L1 is coupled between the first node LX1 and the second node LX2.

The capacitor C11 is coupled between the input voltage V_{IN} and GND. The capacitor C12 is coupled between the negative output voltage V_{ON} and GND. The capacitor C13 is coupled between the positive output voltage V_{OA} and GND. The capacitor C14 is coupled between the positive output voltage V_{OP} and GND.

The resistors R1 and R2 are serially coupled between the positive output voltage V_{OA} and GND for voltage dividing the positive output voltage V_{OA}. The resistors R3 and R4 are serially coupled between the positive output voltage V_{OP} and GND for voltage dividing the positive output voltages V_{OP}. The resistors R5 and R6 are serially coupled between the negative output voltage V_{ON} and a reference voltage Vref for voltage dividing the negative output voltage V_{ON}.

The control circuit 220 is coupled to the power stage 210. The control circuit 220 includes error amplifiers EA1-EA3, an adjust circuit 221 and a control unit 223.

The error amplifier EA1 receives a voltage division from the resistors R5 and R6 to output an internal voltage (or a control voltage) V_{CN}. The error amplifier EA2 receives the reference voltage Vref and a voltage division from the resistors R3 and R4 to output an internal voltage (or a control voltage) V_{CP}. The error amplifier EA3 receives the reference voltage Vref and a voltage division from the resistors R1 and R2 to output an internal voltage (or a control voltage) V_{CA}.

The adjust circuit 221 generates adjust voltages V_{C1_adj} and V_{C3_adj} based on a clock signal CK, the duty cycle D_{N} and the switch control signal S₂. For example, but not limited by, the adjust circuit 221 generates the adjust voltage V_{C1_adj} based on the clock signal CK and the duty cycle D_{N}, and generates the adjust voltage V_{C3_adj} based on the switch control signal S₂.

The control unit 223 is coupled to the inductor L1, the error amplifiers EA1-EA3 and the adjust circuit 221. The control unit 223 generates control voltages V_{C1}, V_{C3}, and control currents I_{S1} and I_{S2} based on the control voltages V_{CN}, V_{CA}, V_{CP}, the adjust voltages V_{C1_adj}, V_{C3_adj}, and the input voltage V_{IN}, wherein the control currents I_{S1} and I_{S2} are proportional to the inductor current IL. For example, but not limited by, the control voltages V_{C1}, V_{C3}, and the currents I_{S1} and I_{S2} are as follows:

V_{C1}=k₁*V_{CA}+k₂*V_{CP}+k₃*V_{CN}−V_{C1_adj}

V_{C3}=V_{C1}−k₇*(V_{IN}/V_{OA})*V_{CA}−k₄*(V_{IN}/V_{OP})*V_{CP}−k₅*(V_{IN}/V_{ON})*V_{CN}−V_{C3_adj}

I_{S1}=V_{IN}*IL/k

I_{S2}=V_{OP}*IL/k@D_{P}

I_{S2}=V_{OA}*IL/k@D_{A}

I_{S2}=V_{ON}*IL/k@D_{N}

The energy generation and distribution circuit 230 is coupled to the control circuit 220, for generating duty cycles D₁, D₃, D_{P}, D_{A} and D_{N} based on the control voltages V_{C1}, V_{C3}, V_{CN}, V_{CA}, V_{CP} and control currents I_{S1} and I_{S2}. The duty cycles D₁, D₃ are also referred as energy generation cycles; and the duty cycles D_{P}, D_{A} and D_{N} are also referred as energy distribution cycles.

The energy generation and distribution circuit 230 includes a first energy generation circuit 231, a second energy generation circuit 233, a first energy distribution circuit 235, a second energy distribution circuit 237 and a third energy distribution circuit 239, which have the same or similar circuit structures and operations.

The first energy generation circuit 231 includes a comparator 231A, a multiplexer 231B, a control current source 231C and a capacitor C₁. Similarly, the second energy generation circuit 233 includes a comparator 233A, a multiplexer 233B, a control current source 233C and a capacitor C₃. The first energy distribution circuit 235 includes a comparator 235A, a multiplexer 235B, a control current source 235C and a capacitor CP. The second energy distribution circuit 237 includes a comparator 237A, a multiplexer 237B, a control current source 237C and a capacitor CA. The third energy distribution circuit 239 includes a comparator 239A, a multiplexer 239B, a control current source 239C and a capacitor CN.

In the first energy generation circuit 231, the multiplexer 231B selects among GND or the control current Isi from the control current source 231C based on the switch control signal S₁. The comparator 231A compares the control voltage V_{C1} and the output from the multiplexer 231B to output the duty cycle D₁.

The second energy generation circuit 233, the first energy distribution circuit 235, the second energy distribution circuit 237 and the third energy distribution circuit 239 outputs the duty cycles D₃, D_{P}, D_{A} and D_{N}, respectively. The circuit operations of the second energy generation circuit 233, the first energy distribution circuit 235, the second energy distribution circuit 237 and the third energy distribution circuit 239 are the same or similar to that of the first energy generation circuit 231 and thus are omitted here.

The logic control and gate driving circuit 240 is couple to the energy generation and distribution circuit 230, for generating switch control signals S₁, S₂, S₃, S_{P}, S_{A}, S_{N} and S_{R} based on the duty cycles D₁, D₃, D_{P}, D_{A} and D_{N}.

The clock generation circuit 250 is coupled to the control circuit 220. The clock generation circuit 250 is for example but not limited by, an oscillator, for generating the clock signal CK to the adjust circuit 221 of the control circuit 220.

In one embodiment of the application, the SIMBO boost-buck inverting converter 200 senses the output voltages V_{OP}, V_{OA}, V_{ON} and the inductor current IL to control the power stage 210.

In one embodiment of the application, the positive output voltages V_{OP}, V_{OA} are generated in buck-boost converting operations; and the negative output voltage V_{ON} is generated in inverting converting operations.

In one embodiment of the application, the duty cycles D₁, D₃ may be referred as energy generation duty cycles during which the input voltage V_{IN} transfers energy to the inductor L1, and the duty cycles D_{P}, D_{A} and D_{N} may be referred as energy distribution duty cycles during which the energy stored in the inductor L1 is transferred to the positive output voltages V_{OP}, V_{OA} and the negative output voltage V_{ON}. The energy distribution duty cycles D_{P}, D_{A} and D_{N} rely on the control voltages V_{CP}, V_{CA} and V_{CN}. In one embodiment of the application, there is theoretically no cross regulation effect, and reasons are as below.

In the energy distribution duty cycle D_{P}, the energy E_{OP} sent to the positive output voltage V_{OP} may be expressed in the equation (1), wherein “IL” refers to the inductor current and “T” refers to the cycle of the clock signal CK:

ε_{OP}=∫₀^{D}^{_{P}}^{T}I_{L}V_{OP}·dt (1)

In the energy distribution circuit 235, the capacitor CP is charged by the current I_{S2} (I_{S2}=V_{OP}*IL/k). Thus, the charge sent to the capacitor CP may be expressed as equation (2):

Q_{OP}=∫₀^{D}^{_{P}}^{T}I_{S2}·dt=∫₀^{D}^{_{P}}^{T}V_{OP}I_{L}/k·dt=C_{P}V_{CP} (2)

Equation (3) is obtained by combining the equations (1) and (2):

E_{OP}=kC_{P}V_{CP} (3)

As described in the equation (3), the energy E_{OP} is decided by the error amplifier output voltage (i.e. the control voltage) V_{CP}.

Similarly, during the energy distribution duty cycle D_{A}, the energy E_{OA} sent to the positive output voltage V_{OA} is as follow:

E_{OA}=∫₀^{D}^{_{A}}^{T}I_{L}V_{OA}·dt=kC_{A}V_{CA} (4-1)

Similarly, during the energy distribution duty cycle D_{N}, the energy E_{ON} sent to the negative output voltage V_{ON} is as follow:

E_{ON}=∫₀^{D}^{_{N}}^{T}I_{L}V_{ON}·dt=kC_{N}V_{CN} (4-2)

Thus, from the above description, in one embodiment of the application, via feedback control, there is theoretically no cross regulation effect.

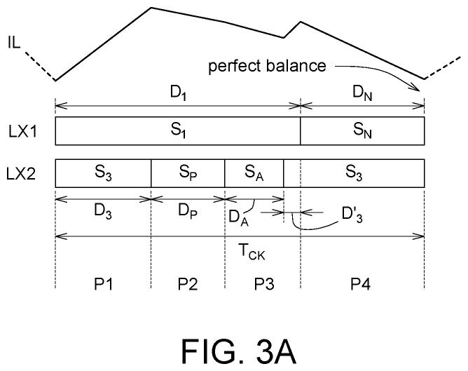

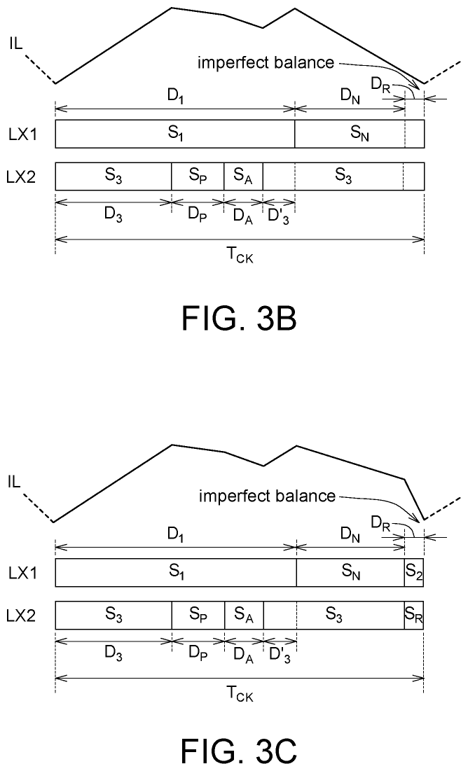

FIG. 3A to FIG. 3C show signal waveforms of the SIMBO boost-buck inverting converter according to one embodiment of the application. FIG. 3A shows perfect balance while FIG. 3B and FIG. 3C show imperfect balance. As shown in FIG. 3A, during one clock cycle T_{CK}, there are four phases: a first phase P1 (i.e. a charge phase), a second phase P2 (i.e. a first positive output voltage outputting phase for outputting the positive output voltage V_{OP}), a third phase P3 (i.e. a second positive output voltage outputting phase for outputting the positive output voltage V_{OA}) and a fourth phase P4 (i.e. a negative output voltage outputting phase for outputting the negative output voltage V_{ON}).

During the first phase P1 (i.e. the charge phase), the switches S₁ and S₃ are turned on to charge the inductor L1 by the input voltage V_{IN}.

During the second phase P2 (i.e. the first positive output voltage outputting phase), the switches S₁ and S_{P} are turned on for transferring energy stored in the inductor L1 to the positive output voltage V_{OP}.

During the third phase P3 (i.e. the second positive output voltage outputting phase), the switches S₁ and S_{A} are turned on for transferring energy stored in the inductor L1 to the positive output voltage V_{OA}.

During the fourth phase P4 (i.e. the negative output voltage outputting phase), the switches S₃ and S_{N} are turned on for transferring energy stored in the inductor L1 to the negative output voltage V_{ON}.

In the application, the term “preface balance” refers that, the energy transferred from the input voltage V_{IN} is totally transferred to all loads (i.e. used in generating the output voltages V_{OP}, V_{OA}, V_{ON}) without any energy waste. In other words, at the end of the duty cycle D_{N}, the inductor current IL reaches a predetermined value (a steady-state value).

Conversely, as the imperfect balance as shown in FIG. 3B and FIG. 3C, at the end of the duty cycle D_{N}, the inductor current IL does not reach the predetermined value (the steady-state value) (for example, being higher than the predetermined value (the steady-state value)), which results energy waste.

As shown in FIG. 3B, at the end of the duty cycle D_{N}, the switches S₃ and S_{N} are turned on for transferring extra energy stored in the inductor L1 to the negative output voltage V_{ON}. By so, the energy waste is minimized but the negative output voltage V_{ON} has higher voltage ripples.

As shown in FIG. 3C, at the end of the duty cycle D_{N}, the switches S₂ and S_{R} are turned on for transferring extra energy stored in the inductor L1 back to the input voltage V_{IN}. By so, the negative output voltage V_{ON} has lower voltage ripples but energy is wasted.

Thus, in one embodiment of the application, via adjusting (reducing) the duty cycles D₃ and D₁ to reduce energy stored in the inductor L1 until perfect balance.

How to adjust (reduce) the duty cycles D₃ and D₁ in one embodiment of the application is described.

The total energy E_{OT} transferred to the output loads (i.e. the output voltages V_{OP}, V_{OA}, V_{ON}) are as expressed in the equation (5):

E_{OT}=∫₀^{D}^{_{P}}^{T}I_{L}V_{OP}·dt+∫₀^{D}^{_{A}}^{T}I_{L}V_{OA}·dt+∫₀^{D}^{_{N}}^{T}I_{L}V_{ON}·dt

E_{OT}=kCV_{P}V_{CP}+kC_{A}V_{CA}+kC_{N}V_{CN} (5)

The total input energy E_{IT} from the input voltage V_{IN} is expressed in the equation (6):

E_{IT}=∫₀^{D}^{₁}^{T}I_{L}V_{IN}·dt=kC₁V_{C1} (6)

In the steady state (as shown in FIG. 3A), E_{OT}=E_{IT}. Thus, the following equation (7) is obtained:

$${V}_{C 1} = k \frac{{C}_{P}}{{C}_{1}} {V}_{CP} + k \frac{{C}_{A}}{{C}_{1}} {V}_{CA} + k \frac{{C}_{N}}{{C}_{1}} {V}_{CN} = {k}_{1} {V}_{CA} + {k}_{2} {V}_{CP} + {k}_{3} {V}_{CN} \qquad ( 7 )$$

In the equation (7), the coefficients k₁, k₂, k₃ are all positive values.

As shown in FIG. 3A, the duty cycle D₁ of the switch S₁ will decide the energy generation duration of the SIMBO boost-buck inverting converter 200. Thus, the duty cycles are expressed as the equation (8), wherein D₃′ refers to the overlap phase of S1 and S3 before the duty cycle D3:

D₁=D_{A}+D_{P}+D₃+D₃′ (8)

During the duty cycles D₃ and D₃′ (within the duty cycle D₁), the inductor L1 is charged; and energy stored in the inductor L1 is transferred to the output voltages V_{OP}, V_{OA}, V_{ON} during the duty cycles D_{P}, D_{A}, D_{N}.

During the clock cycle T_{CK}, if the energy generated in the duty cycle D₁ is totally equal to the energy transferred to the output voltages V_{OP}, V_{OA}, V_{ON}, then the equation (9) is as follows:

T_{CK}=D₁+D_{N} (9)

However, in the transient state (as shown in FIG. 3B and FIG. 3C), the energy generated in the duty cycle D₁ is larger than the energy transferred to the output voltages V_{OP}, V_{OA}, V_{ON}, then the equation (10) is as follows:

T_{CK}>D₁+D_{N} (10)

Equation (10) refers that, during the clock cycle, after generating the output voltages, there is extra energy stored in the inductor L1. Thus, the residual energy stored in the inductor L1 is released to the negative output voltage V_{ON} during the duty cycle D_{R} (as shown in FIG. 3B, which results large voltage ripple in the negative output voltage V_{ON}), or the residual energy stored in the inductor L1 is recycled to the input voltage V_{IN} (as shown in FIG. 3C, which results lower energy conversion efficiency), wherein T_{CK}=D₁+D_{N}+D_{R}.

Thus, in order to achieve perfect balance between the total input energy and the total output energy during the clock cycle, in one embodiment of the application, the input energy is adjusted (reduced) by adjusting (reducing) the duty cycles D₁ and D₃ to achieve the equation (9) (T_{CK}=D₁+D_{N}) and by establishing a feedback mechanism. Therefore, the control voltage V_{C1} is as follows:

V_{C1}=k₁V_{CA}+k₂V_{CP}+k₃V_{CN}−V_{C1_adj} (11)

In one embodiment of the application, via adjusting the adjust voltage V_{C1_adj} generated from the adjust circuit 221, the duty cycle D₁ is adjusted until the perfect balance in the equation (9). In other words, if the duty cycle D₁ is too large, then the adjust voltage V_{C1_adj} is not zero and thus the control voltage V_{C1} is smaller which results a smaller duty cycle D₁. The operations are repeated until perfect balance.

Further, in FIG. 3A and FIG. 3C, the positive output voltages V_{OP} and V_{OA} are generated under the boost mode; and during the duty cycles D_{P} and D_{A}, the inductor current IL is decreased, wherein the coefficients k₄ and k₅ are positive values.

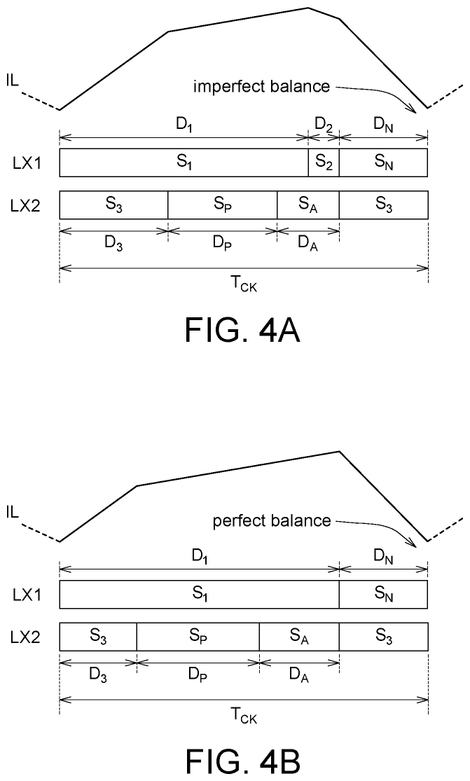

FIG. 4A to FIG. 4B show signal waveforms of the SIMBO boost-buck inverting converter according to one embodiment of the application. FIG. 4A shows imperfect balance while FIG. 4B shows perfect balance.

In FIG. 4A, the duty cycle D₂ is residual, which causes energy waste. Thus, in one embodiment of the application, energy stored in the inductor L1 is decreased by adjusting (reducing) the duty cycle D₃ until the duty cycle D₂ is minimized or totally eliminated. How to achieve perfect balance in FIG. 4B is described.

The equation (8) is rearranged as:

D₃=D₁−D_{A}−D_{P}−D₃′ (12)

V_{C3}=V_{C1}−k₄V_{CA}−k₅V_{CP}−V_{C3_adj} (13)

In FIG. 4A and FIG. 4B, the positive output voltages V_{OP} and V_{OA} are generated in the buck mode, wherein during the duty cycle D₁ (which is overlapped with the duty cycles D_{P}, D_{A}), the inductor current IL is increasing. When energy stored in the inductor L1 is enough, the duty cycle D₁ may be ended within the duty cycles D_{P} or D_{A}. The switch S₂ is turned on to transfer the required energy to the positive output voltages V_{OP} and V_{OA} until the duty cycle D_{A} is ended. Then, the switches S₃ and S_{N} are turned on to transfer residual energy in the inductor L1 to the negative output voltage V_{ON}.

Compared with the boost mode, the buck mode requires a smaller duty cycle D₃ because the energy is still transferred into the inductor L1 during the duty cycles D_{P} and D_{A}. However, heavier the buck mode, smaller the duty cycle D₃. The equation (13) is rearranged as:

$$V \text{?} = {V}_{C 1} - k \text{?} \frac{{V}_{IN}}{{V}_{CA}} {V}_{CA} - k \text{?} \frac{{V}_{IN}}{{V}_{OP}} {V}_{CP} - V \text{?} \qquad ( 14 )$$

$$\text{?} \text{indicates text missing or illegible when filed}$$

In the equation (14), “(V_{IN}/V_{OP})>1” and “(V_{IN}/V_{OP})<1” refer to the buck mode operations and the boost mode operations. Thus, higher (V_{IN}/V_{OP}) results the smaller adjust voltage V_{C3} and the smaller duty cycle D₃.

In one embodiment of the application, in order to achieve a better conversion efficiency, in the buck mode, the inductor L1 is charged during the duty cycles D_{P} and D_{A} and to minimize the duty cycle D₂ for minimizing a peak value of the inductor current IL. This means small conduction loss and small switching loss, because the inductor current IL has small peak value and the duty cycle D₂ of the switch S₂ is removed. Thus, in one embodiment of the application, the adjust voltage V_{C3_adj} from the adjust circuit 221 is used to reduce the duty cycle D₃ until the duty cycle D₂ is minimized.

In one embodiment of the application, the positive output voltages V_{OP} and V_{OA} are generated in the buck-boost mode (i.e. the positive output voltages V_{OP} and V_{OA} are higher than, equal to or lower than the input voltage V_{IN}); and the negative output voltage V_{ON} is generated in the inverting mode, wherein the buck-boost mode and the inverting mode are completed during one clock cycle.

In one embodiment, by generating the adjust voltage, the duty cycles are adjusted to reduce extra energy stored in the inductor until perfect balance (as shown in FIG. 3A to FIG. 3C and FIG. 4A to FIG. 4B). Thus, in one embodiment of the application, large switching frequency variation and high voltage ripples are prevented, and there is no cross regulation effect.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A SIMBO (Single Inductor Multiple Bipolar Output) buck-boost inverting converter including:
a power stage for receiving an input voltage to generate a first positive output voltage, a second positive output voltage and a negative output voltage, the power stage including a plurality of switches and an inductor;
a control circuit coupled to the power stage, for generating a plurality of control voltages based on the first positive output voltage, the second positive output voltage, the negative output voltage and a current of the inductor;
an energy generation and distribution circuit coupled to the control circuit, for generating a plurality of duty cycles based on the control voltages; and
a logic control and gate driving circuit coupled to the energy generation and distribution circuit, for generating a plurality of switch control signals for controlling the switches of the power stage based on the duty cycles;
wherein the control circuit and the energy generation and distribution circuit feedback-control and adjust the duty cycles to adjust a balance between an input energy from the input voltage and an output energy sent to the first positive output voltage, the second positive output voltage and the negative output voltage.

2. The SIMBO buck-boost inverting converter according to claim 1, further including a clock generation circuit coupled to the control circuit, for generating a clock signal to the control circuit.

3. The SIMBO buck-boost inverting converter according to claim 1, wherein the control circuit includes:
a plurality of error amplifiers, coupled to the power stage, for generating a first control voltage, a second control voltage and a third control voltage of the control voltages based on the first positive output voltage, the second positive output voltage, the negative output voltage and a reference voltage;
an adjust circuit for generating a plurality of adjust voltages based on one of the duty cycles, one of the switch control signals and a clock signal; and
a control unit coupled to the error amplifiers and the adjust circuit, for generating a fourth control voltage and a fifth control voltage of the control voltages and a plurality of control currents based on the first control voltage, the second control voltage, the third control voltage, the inductor current and the adjust voltages, wherein the control currents are proportional to the inductor current.

4. The SIMBO buck-boost inverting converter according to claim 3, wherein the energy generation and distribution circuit includes:
a plurality of energy generation circuits coupled to the control unit, for generating a first duty cycle and a second duty cycle of the duty cycles based on the fourth control voltage, the fifth control voltage and a first control current of the control currents; and
a plurality of energy distribution circuits coupled to the control unit, for generating a third duty cycle, a fourth duty cycle and a fifth duty cycle of the duty cycles based on the first control voltage, the second control voltage, the third control voltage and a second control current of the control currents.

5. The SIMBO buck-boost inverting converter according to claim 4, wherein in generating the first positive output voltage and the second positive output voltage under buck mode or boost mode, in response to a first adjust voltage of the adjust voltages from the adjust circuit, the control unit adjusts the fourth control voltage and the fifth control voltage, and the energy generation circuits adjust the first duty cycle and the second duty cycle to adjust the balance between the input energy and the output energy.

6. The SIMBO buck-boost inverting converter according to claim 5, wherein in generating the first positive output voltage and the second positive output voltage under buck mode, in response to a second adjust voltage of the adjust voltages from the adjust circuit, the control unit adjusts the fifth control voltage, and the energy generation circuits adjust the second duty cycle to minimize a peak value of the inductor current.

7. A control method for SIMBO (Single Inductor Multiple Bipolar Output) buck-boost inverting converter, the control method including:
receiving an input voltage to generate a first positive output voltage, a second positive output voltage and a negative output voltage by a power stage, the power stage including a plurality of switches and an inductor;
generating a plurality of control voltages based on the first positive output voltage, the second positive output voltage, the negative output voltage and a current of the inductor;
generating a plurality of duty cycles based on the control voltages; and
generating a plurality of switch control signals for controlling the switches of the power stage based on the duty cycles;
wherein feedback-controlling and adjusting the duty cycles to adjust a balance between an input energy from the input voltage and an output energy sent to the first positive output voltage, the second positive output voltage and the negative output voltage.

8. The control method for the SIMBO buck-boost inverting converter according to claim 7, further including generating a clock signal.

9. The control method for the SIMBO buck-boost inverting converter according to claim 7, further including:
generating a first control voltage, a second control voltage and a third control voltage of the control voltages based on the first positive output voltage, the second positive output voltage, the negative output voltage and a reference voltage;
generating a plurality of adjust voltages based on one of the duty cycles, one of the switch control signals and a clock signal; and
generating a fourth control voltage and a fifth control voltage of the control voltages and a plurality of control currents based on the first control voltage, the second control voltage, the third control voltage, the inductor current and the adjust voltages, wherein the control currents are proportional to the inductor current.

10. The control method for the SIMBO buck-boost inverting converter according to claim 9, further including:
generating a first duty cycle and a second duty cycle of the duty cycles based on the fourth control voltage, the fifth control voltage and a first control current of the control currents; and
generating a third duty cycle, a fourth duty cycle and a fifth duty cycle of the duty cycles based on the first control voltage, the second control voltage, the third control voltage and a second control current of the control currents.

11. The control method for the SIMBO buck-boost inverting converter according to claim 10, further including:
in generating the first positive output voltage and the second positive output voltage under buck mode or boost mode, in response to a first adjust voltage of the adjust voltages, adjusting the fourth control voltage and the fifth control voltage, and adjusting the first duty cycle and the second duty cycle to adjust the balance between the input energy and the output energy.

12. The control method for the SIMBO buck-boost inverting converter according to claim 11, further including:
in generating the first positive output voltage and the second positive output voltage under buck mode, in response to a second adjust voltage of the adjust voltages, adjusting the fifth control voltage, and adjusting the second duty cycle to minimize a peak value of the inductor current.
